(19) United States
(12) Patent Application Publication
(10) Pub. No.: US 2007/0011839 A1
(43) Pub. Date: Jan. 18, 2007

(54) Method and arrangement for assembling a windscreen wiper device on a motor vehicle

(75) Inventors: Joël Princet, Chatellerault (FR); Jerome Valliere, Les Omes (FR); Sebastien Bordas, Antran (FR); Pascal Morin, Chatelleraut (FR); Jean-Paul Boissac, Chatellerault (FR); Laurent Collinet, la Rocha Posay (FR); Serge Predeau, Chatellerault (FR)

Correspondence Address: OSHA LIANG L.L.P., 1221 MCKINNEY STREET, SUITE 2800, HOUSTON, TX, 77010, US

(73) Assignee: Valeo Systemes d"Essuyage, La Verriere (FR)

(21) Appl. No.: 10/552,169

(22) PCT Filed: Apr. 2, 2004
(86) PCT No.: PCT/EP04/03528

§ 371 Date: Aug. 2, 2006

(30) Foreign Application Priority Data
Apr. 11, 2003 (FR) 0304664

(51) Int. Cl. B60S 1/02

(52) U.S. Cl. 15/250.31

(57) ABSTRACT

A method is disclosed for assembling a windscreen-wiper mechanism having a support plate on an internal face of a body structure element that extends globally vertically at a rear of a motor vehicle. The method includes the steps of positioning the support plate relative to the internal face of the body structure element and joining the plate to the internal face of the body structure element. The positioning step includes moving the plate relative to the body structure element along a first direction, and the joining step includes rotating the plate about the first direction.

The invention provides a method for assembling a mechanism for driving a wiping device on a body structure element.

The invention provides, more specifically, a method for assembling a windscreen wiper comprising a support plate that has at least one driving shaft of a wiper blade with a longitudinal main axis, on an internal face of a body structure element that extends globally vertical at the rear of a motor vehicle, through an opening in the body structure element.

Motor vehicles generally comprise a rear opening in which a cavity is made, which is blocked by a glass panel. In order to clean the glass panel, vehicles comprise a rear wiper device.

The wiper device comprises a shaft for driving a wiper blade, which is driven in rotation by an electric motor, the rotation of which is guided by a bearing.

There is a known way for fixing the wiping device to a plate which, in turn, is fixed to the internal face of the opening by means of a screw-nut assembly.

It is necessary to provide at least three fixing points, in order to allow the wiping device to be immobilised, and to prevent it from rotating in relation to the glass panel.

Mounting of the plate and the wiping device is relatively complex, since it requires, on the one hand, positioning the plate in relation to the opening according to a longitudinal translation movement and, on the other hand, fixing the plate to the glass panel by means of the screw-nut assembly.

Such solutions are not satisfactory. Indeed, they are heavy, bulky and take a relatively long time to complete.

Furthermore, the screw-nut assembly requires at least one step for screwing, which is particularly difficult since it requires maintaining the plate in position during the screwing step.

Finally, assembly using a screw-nut requires the plate to be positioned relatively precisely in relation to the glass panel, which requires using a complex, specific tool.

Documents U.S. Pat. No. 6,308,372 and WO-A-00.6429 provide means for assembling the plate by elastic fitting and by cooperation of complementary shapes.

Assembly is carried out by inserting a finger in a complementary housing by means of longitudinal translation and then by rotation around a transverse axis.

Although such an attachment method does not use assembly of the screw-nut type, it turns out not to be very suitable for a wiping mechanism associated to the rear opening of the vehicle, due to the rotation required around a transverse axis.

Indeed, since the driving shaft passes through the glass panel, it is necessary to provide a large orifice to allow for the movement of the driving shaft during this rotation. This orifice then poses considerable problems, mainly in that relating to hermetically sealing the orifice.

The invention has the aim of providing a method for mounting and fixing the plate by cooperation of complementary shapes, which is particularly suited for mounting a wiping mechanism associated to the rear opening of a vehicle.

To this end, the invention provides a method of the type described previously, characterised in that the positioning step and the joining step each consist of moving the plate in relation to the body structure element, following and/or around a same direction.

Thus, the positioning step is carried out globally by translation following the said direction, while the joining step is carried out by rotation around the same direction or by translation along the said same direction.

According to other characteristics of the invention:

the said direction is parallel to the longitudinal axis of the driving shaft;

the positioning and joining steps consist of successive longitudinal front-to-back translation movements of the plate in relation to the body structure element;

the positioning and joining steps consist successively of a longitudinal front-to-back translation movement of the plate in relation to the body structure element, and then in a rotation movement of the plate in relation to the body structure element, around the longitudinal axis of the driving shaft:

the method comprises a final step of locking the plate in its mounted position on the internal face of the body structure element.

The invention also provides an arrangement for mounting and fixing a windscreen-wiper mechanism following a method according to any of the preceding claims, characterised in that the plate comprises means for being positioned coaxially to the longitudinal axis of the driving shaft and means for being positioned at an angle around the longitudinal axis.

According to further characteristics of the invention:

the plate comprises a cylindrical barrel with a circular section for guiding the rotation of the driving shaft, which is designed to be received in a complementary housing in the body structure element to carry out the positioning coaxially in relation to the longitudinal axis, and to provide a hermetic seal of the point where the structure element is crossed.

the plate or the body structure element have a finger with longitudinal orientation or radial orientation in relation to the longitudinal axis, which is received in a complementary housing in the body structure element or in the plate, respectively, for angular positioning of the plate around the longitudinal axis;

the finger is kept in its mounted position inside the associated housing by fitting together of complementary shapes, and mainly by elastic fitting of elements that also form vibration dampers;

the body structure element, or the plate, have an elastic orientation clamp that is globally tangential to the longitudinal axis, which receives a finger from the plate, or the body structure element, respectively, for angular positioning of the plate around the longitudinal axis and for maintaining the plate in its mounted position on the body structure element;

at least one of the branches of the clamp comprises a boss that projects in relation to the face opposite the other branch of the clamp, towards the inside of the clamp, and which is designed to be received in a hollow complementary housing of the associated finger;

the body structure element has an elastic clamp that is suited for receiving the external carcass of a motor for driving a wiping mechanism, for angular positioning of the plate around the longitudinal axis and for maintaining the plate in its mounted position in relation to the body structure element;

the body structure element comprises a transverse plate to which the plate of the wiping device is fixed;

the clamp is formed integral with the transverse plate by means of bending and cutting;

the plate has at least one clamp, the branches of which are arranged on either side of the transverse plate;

the plate has at least one longitudinal finger, the external cylindrical wall of which comprises a peripheral gorge, and the finger is designed to be inserted in a groove of the transverse plate so that, when the plate is in mounted position on the transverse plate, the edge of the groove is received at least partly in the gorge of the finger

the edge of the groove comprises radial corrugations in relation to the axis of the finger, designed to lock the movement of the finger in the groove;

the finger has a locking tab, which is received at least partly in the groove, in order to lock the finger in its position in the groove;

the finger is arranged radially at a distance from the longitudinal axis of the driving shaft;

the orientation of the clamp is globally tangential in relation to the longitudinal axis;

the plate has a portion that is designed to be formed integral with the body structure element by means of a locking element with axial action, mainly by means of a screw;

the arrangement comprises at least one finger with longitudinal orientation received in a complementary housing, and axial immobilisation means for at least one finger in its complementary housing.

Other characteristics and advantages of the invention will become apparent from reading the following detailed description, with the following figures attached to aid its understanding, in which:

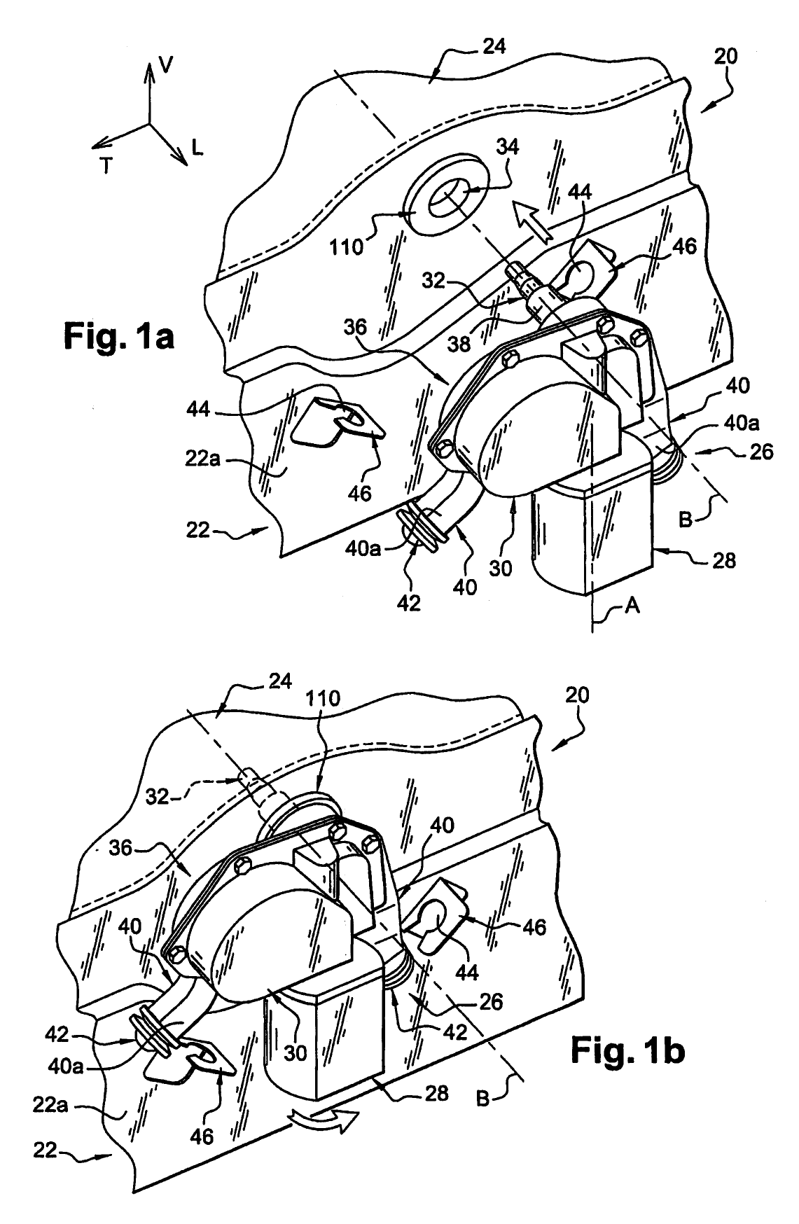

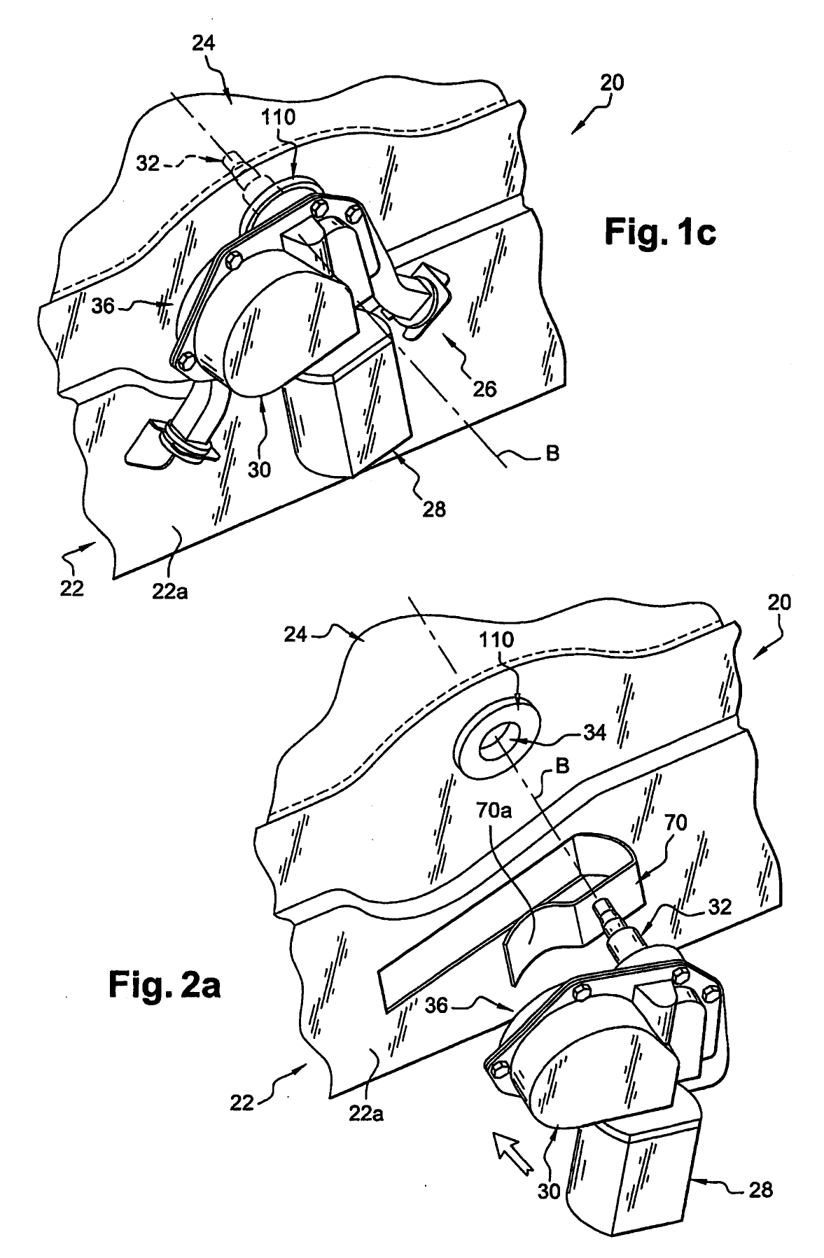

FIGS. 1a to 1c are schematic perspective views, from the front, of an arrangement according to the invention, in which the plate has radial fingers that are received in tangential openings, and which shows the successive stages for mounting and joining the plate to the structure element, according to the invention;

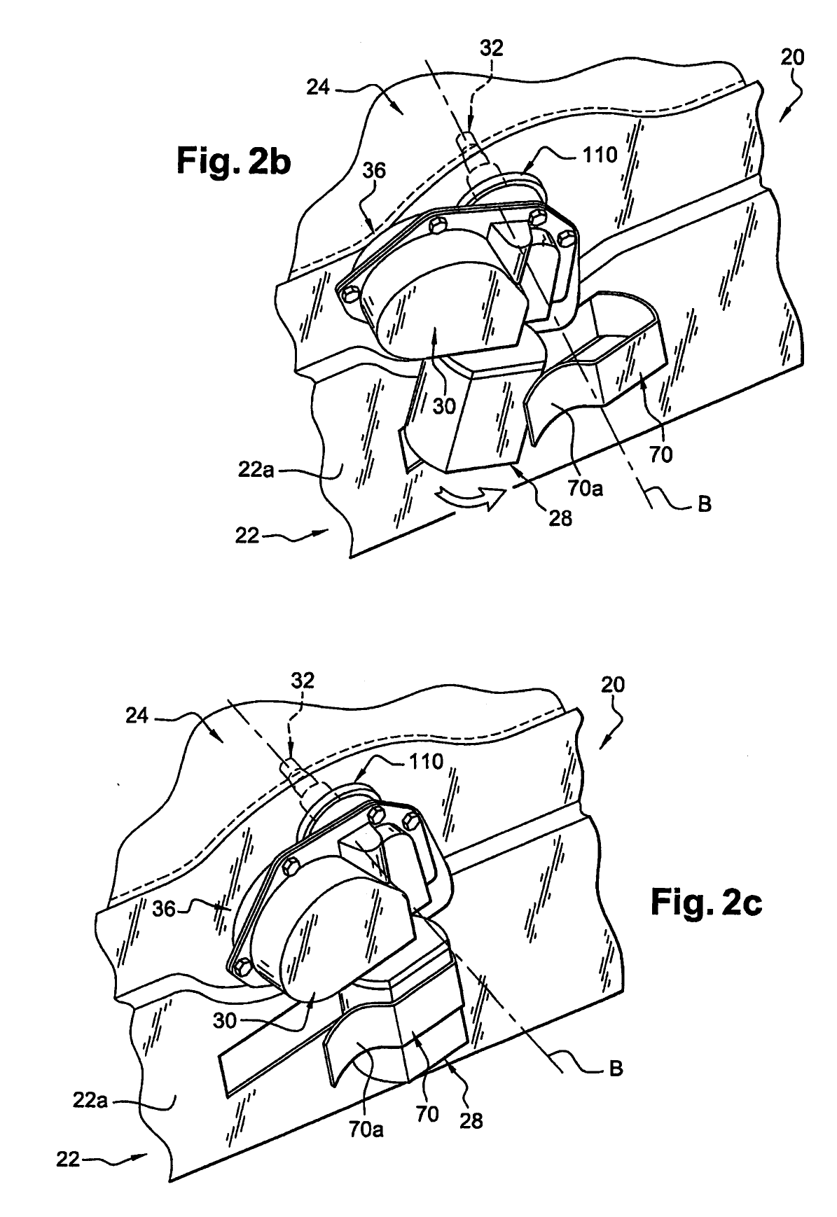

FIGS. 2a to 2c are similar views to those shown in FIGS. 1a to 1c, in which the means for joining the plate comprise a band that forms a clamp made by cutting and bending a part of the structure element;

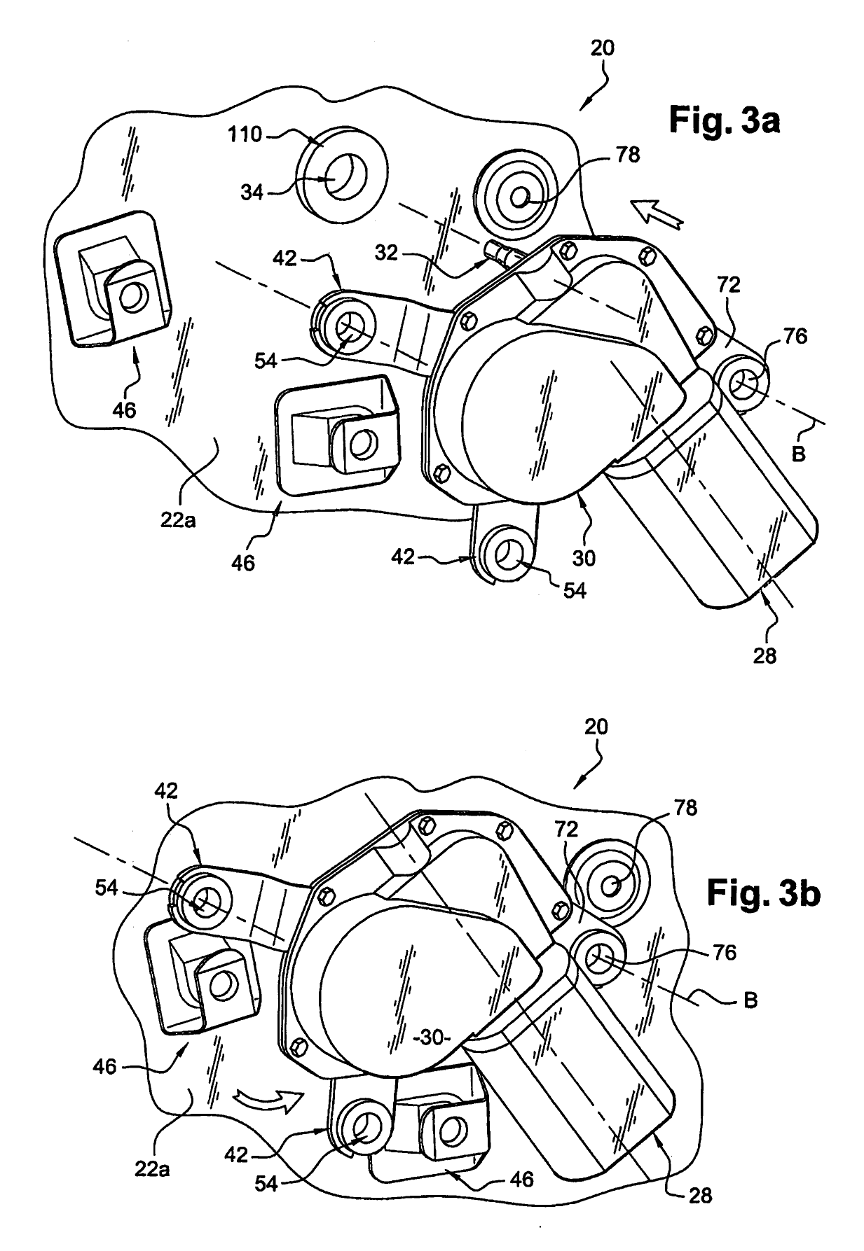

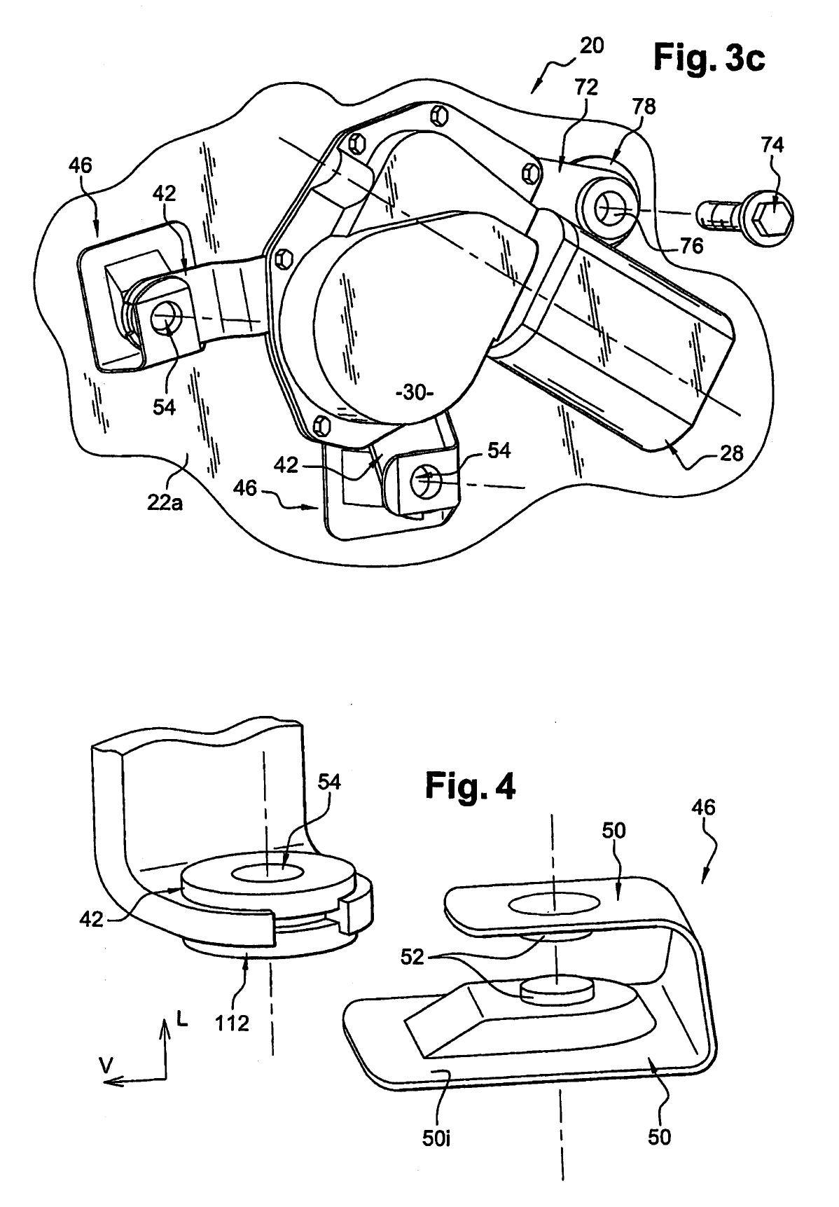

FIGS. 3a to 3c are similar views to those shown in FIGS. 1a to 1c, in which the means for joining the plate comprise tangential clamps that receive the radial fingers;

FIG. 4 is a large-scale detail view of a radial finger and the associated tangential clamp;

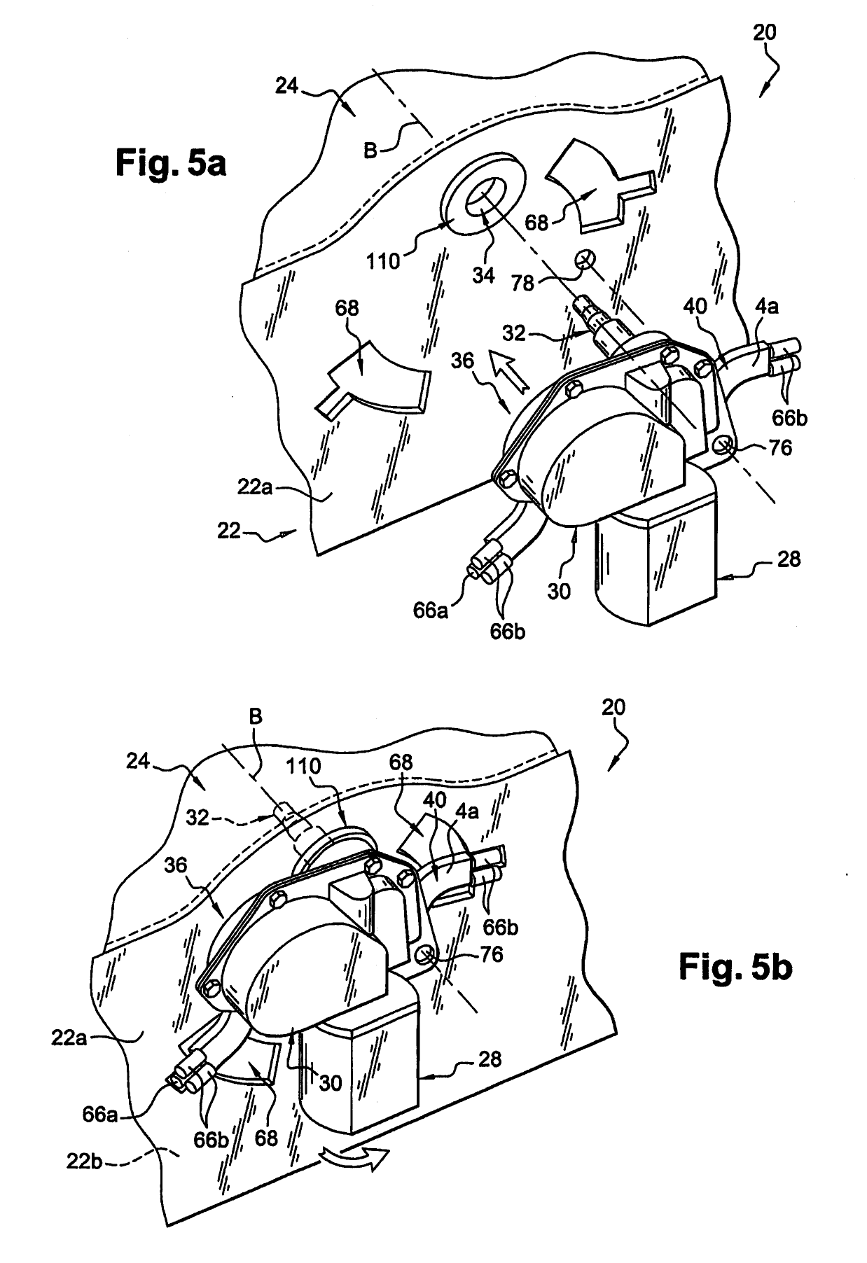

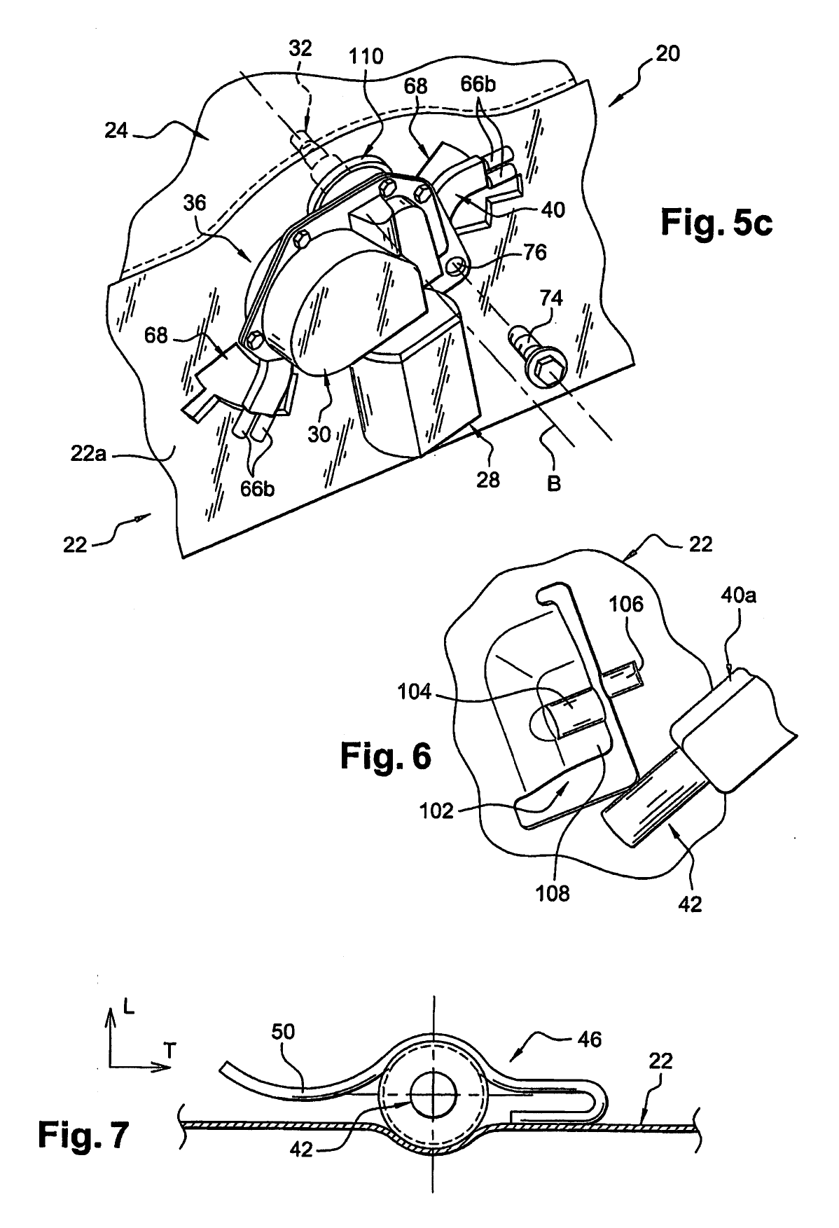

FIGS. 5a to 5c are similar views to those shown in FIGS. 1a to 1c, in which the means for joining the plate comprise a set of three radial fingers that extend from the free end of each radial arm;

FIGS. 6 to 10 are large-scale detail views of alternative embodiments of the joining means;

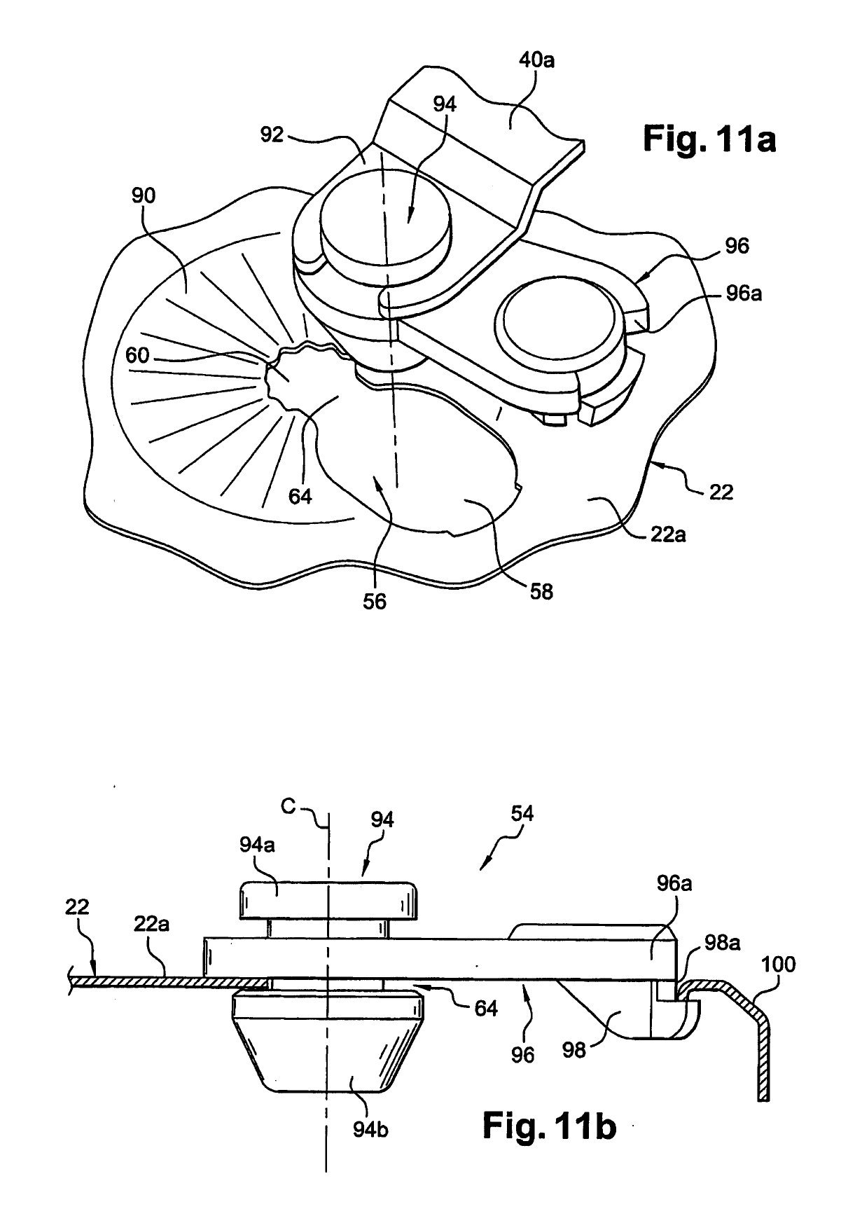

FIGS. 11a and 11b are further detail views on a larger scale of another embodiment of the longitudinal finger, which comprises a locking tab.

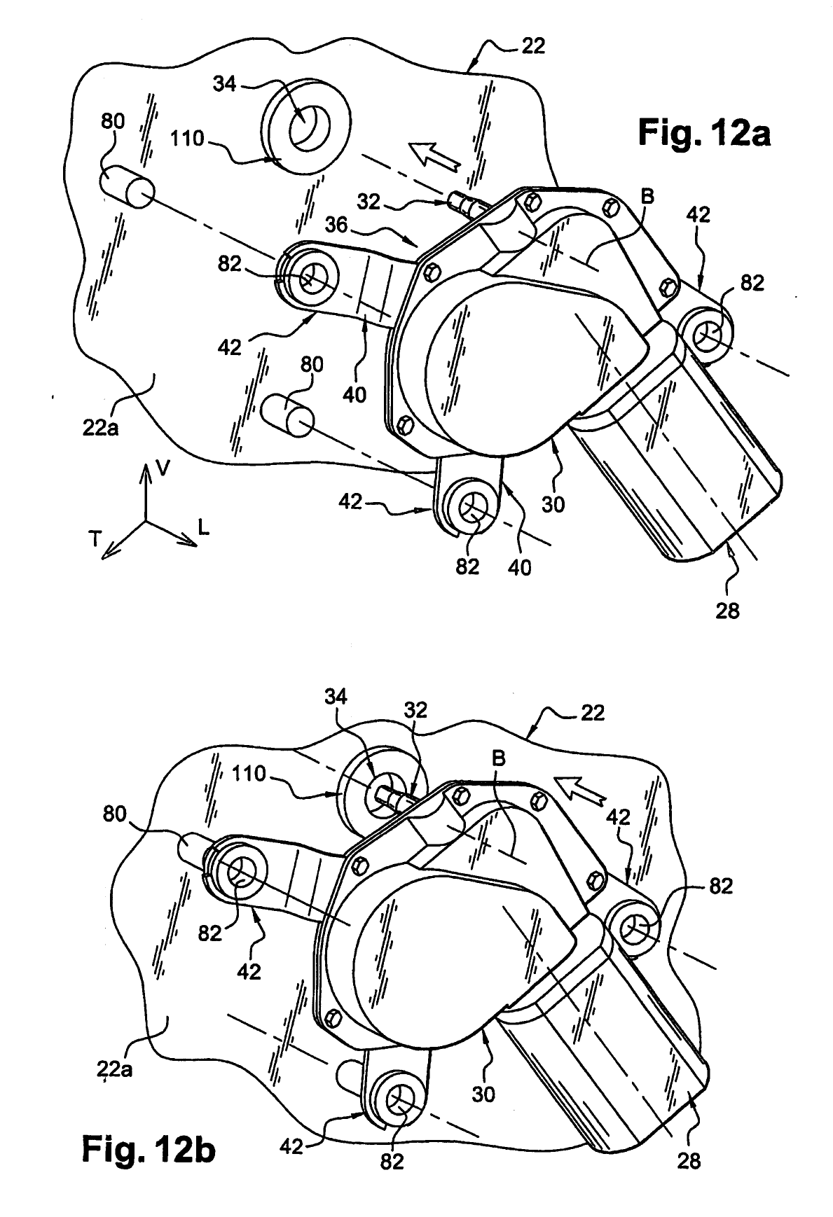

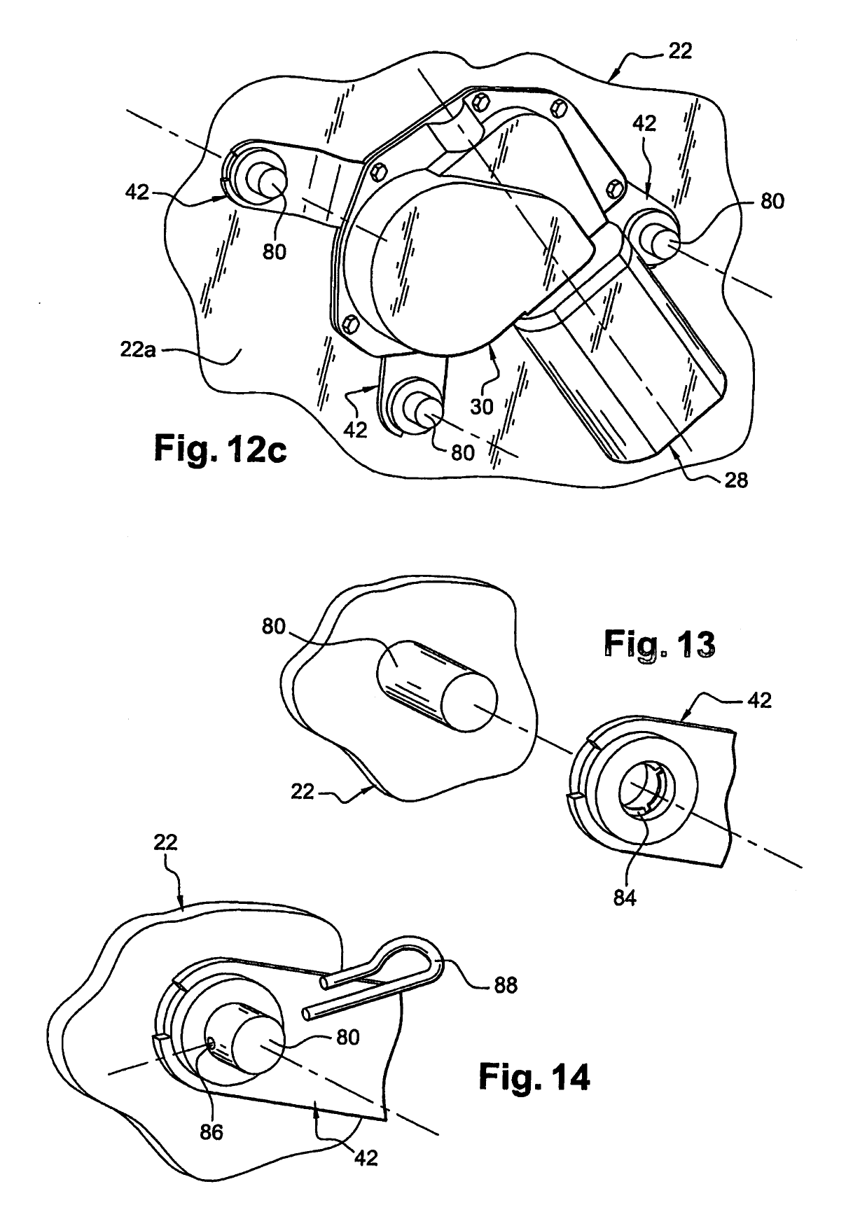

FIGS. 12 to 12c are similar views to those shown in FIGS. 1a to 1c, in which the plate is designed to be joined to the structure element following a translation movement towards the rear, according to another aspect of the invention;

FIG. 13 is a detail view on a larger scale of the means for joining the plate to the structure element according to the embodiment of the invention shown in FIGS. 9a to 9c; and

FIG. 14 is a view similar to that shown in FIG. 14, according to which the joining means comprise a transverse pin for locking the joining of the plate to the structure element.

For the description of the invention, the vertical, longitudinal and transverse orientations will be referred to with the markers V, L and T shown in the figures.

In addition, the back-to-front orientation will be used to refer to the longitudinal direction, from right to left in relation to FIG. 1.

In the following description, identical, similar or analogue elements will be referred to using the same reference numbers.

The figures show a rear opening 20 of a motor vehicle, mainly a tailgate, which extends vertically transversally at the rear of the vehicle, and which comprises mainly a structure element 22, consisting generally of a sheet shaped by cutting and bending, and a glass panel 24.

The structure element 22 has, on its front face 22a, which is the internal face 20 of the opening 20, a driving mechanism 26 of a device for wiping the outer face of the glass panel 24.

The driving mechanism 26 comprises a driving motor 28, the main axis A of which extends in a transverse vertical plane, a reducing gear 30, a driving shaft 32,with a longitudinal main axis B which extends towards the rear, passing through an orifice 34 in the structure element 22.

The driving mechanism 26 also comprises a plate 36 for supporting the motor 28, the reducing gear 30 and the driving shaft 32, which is fixed to the front face 22a of the structure element 22.

The plate can be an individual component, or it can be one of the elements of the housing of the reducing gear of the motor, for example, the closing plate of the reducing gear.

The plate 36 also comprises a cylindrical barrel 38, for guiding the rotation of the driving shaft 32 around its longitudinal main axis B, which is received in the orifice 34 of the structure element 22.

The fixing of the plate 36 on the front face 22a of the structure element 22a is carried out mainly in two steps, which consist of a first step in which the plate 36 is positioned in relation to the structure element 22, followed by a second step in which the plate is joined to the front face 22a of the structure element 22.

Positioning of the plate 36 in relation to the structure element 22 defines the position of the area wiped by the wiping blade when it moves around the longitudinal axis B.

Thus, it is necessary on the one hand to position the driving shaft 32, in other words the longitudinal axis B, vertically and transversally in relation to the structure element 22, and then to position the plate 36 angularly and longitudinally around this longitudinal axis B.

The vertical and transversal positioning of the driving shaft 32 is carried out by means of the cylindrical guiding barrel 38, which is received in the orifice 34 of the structure element 22, which has a complementary shape.

These means for positioning the driving shaft 32 are not compatible with moving the plate 36 in relation to the front face 22a of the structure element 22 in the vertical or transversal directions.

This is why, according to the invention, the successive movements of the plate 36 in relation to the front face 22a of the structure element 22, during the two steps of positioning and joining consist of movements in the same direction, which here, according to a preferred embodiment of the invention, is the direction of the longitudinal main axis B of the driving shaft 32.

According to the invention, as shown in the figures, the positioning step consists of a longitudinal translation movement of the plate 36 towards the rear in relation to the front face 22a, in order to insert the barrel 38 in the orifice 34.

At the end of this positioning step, the plate 36 is positioned vertically and transversally in relation to the structure element 22, so that the driving shaft 32 extends vertically and transversally in its end position.

According to the invention, the second step for joining the plate to the front face 22a of the structure element 22 consists of a rotation movement of the plate 36 around the longitudinal main axis B of the driving shaft 32.

Thus, according to this second step, the driving shaft 32 is not shifted vertically or transversally, and the function of the second step is therefore merely to position the driving mechanism 26 angularly around the longitudinal main axis B.

FIGS. 12a to 12c, 13 and 14 show an alternative embodiment of the invention according to which the second step of joining the plate 36 to the front face 22a of the structure element 22 consists of an additional movement of longitudinal translation of the plate 36 towards the rear, beyond the position of the plate 36 at the end of the first positioning step.

According to this alternative embodiment of the invention, it is no longer necessary to move the driving shaft 32 vertically or transversally.

Finally, according to another aspect of the invention and regardless of the method used for carrying out the step for joining the plate 36 to the front face 22a of the structure element 22, it is followed by a final step in which the plate 36 is locked in a mounted position on the front face 22a of the structure element 22.

The positioning of the driving mechanism makes it possible to define the position of the wiping area of the windscreen-wiper blade of the glass panel.

Thus, it is necessary on the one hand to position the longitudinal rotation axis B vertically and transversally and, on the other hand, to position the driving mechanism 26 angularly around this longitudinal axis B.

Positioning of the plate 36 in relation to the front face 22a of the structure element 22 is carried out by means of the barrel 38 on the plate 36, which is received in the orifice 34 of the structure element 22.

For this purpose, the external cylindrical wall 38e of the barrel 38 is cylindrical, and with a globally circular vertical transversal cross-section, and the cross-section of the orifice 34 is complementary to the cross-section of the external cylindrical wall 38e of the barrel 38, in other words, it is cylindrical with a longitudinal main axis coinciding with the longitudinal axis B of the driving shaft.

In addition to the means for positioning it in relation to the front face 22a of the structure element 22, the plate 36 comprises means for joining it with the front face 22e of the structure element 22, which provide its angular position around the axis B of the driving shaft 32 at the end of the second joining step.

According to a preferred embodiment of the invention, and as can be seen in the figures, joining of the plate 36 to the front face 22e of the structure element 22 is carried out by fitting together complementary shapes.

According to a first aspect of the invention, and as mentioned previously, the second joining step consists of a rotation movement of the plate 36 in relation to the front face 22a of the structure element 22 around the longitudinal axis B of the driving shaft 32.

Angular positioning of the plate 36 in relation to the structure element 22, around the longitudinal axis B, is carried out through use of joining means that are positioned, according to a preferred embodiment of the invention, at a radial distance in relation to the longitudinal axis B.

FIGS. 1a to 1c show a first embodiment of the means for joining the plate 36, according to which the plate 36 has two radial arms 40 that each extend globally radially in relation to the longitudinal axis B, and the free radial end 40a of which has a radial finger 42.

Each radial finger 42 is inserted in an opening 44 made in an associated support element 46, which is placed on the front face 22a of the structure element 22.

These support elements 46 each consist of a plate of sheet metal made by cutting and bending the structure element 22, and which extends along a longitudinal plane that is globally tangential to the longitudinal axis B.

The opening 44 of each support element 46 consists globally of a groove that extends globally tangentially in relation to the longitudinal axis B, from an edge of the support element 46 located above it, in relation to the movement of the second joining step, and it comprises a first portion with a width that is less than the width of the radial finger 42, and a bottom that defines a housing that is complementary to the radial finger 42.

Thus, when the finger 42 is in position in the bottom of the opening 44, the fact that the first portion of the opening 44 is less wide than the finger 42 prevents the finger 42 from coming loose from the bottom of the opening 44.

Since the finger 42 cannot come loose from the bottom of the opening 44, the means for joining the plate 36 with the structure element 22 simultaneously maintain the position of the plate 36, its angular position around the longitudinal axis B, as well as the longitudinal position of the plate 36 in relation to the structure element 22.

In addition, the plate 36 comprises several radial arms 40, two in this case, to prevent any movement of the plate 36 around an axis located in a transversally vertical position.

FIGS. 3a, 3b, 3c and 4 show another embodiment of the support elements 46, according to which the support elements 46 form a U-shaped elastic clamp which is oriented globally tangentially in relation to the longitudinal axis B, and the branches 50 of which extend parallel to the front face 22a of the structure element 22.

As can be seen in greater detail in FIG. 4, each branch 50 comprises a boss 52 which projects longitudinally towards the bottom of the clamp 46, from the internal face 50i of the branch 50, opposite the other branch 50.

According to this same alternative, the radial finger 42 comprises a longitudinal orifice 54 in which the boss 52 is received when the plate 36 is in mounted position on the front face 22a of the structure element 22, in order to ensure that the plate 36 is maintained in its position.

During the joining step, each support element 46 forming a clamp deforms elastically so that its branches 50 are moved apart to allow the finger 42 to pass in between the bosses 52. Then, once the housing 54 is opposite the bosses 52, the branches return elastically to their initial position in which the bosses 52 are received inside the housing 54.

According to a preferred embodiment of the invention, the bosses 52 and the housing 54 are of complementary sizes, in order to carry out the angular positioning of the plate 36 around the longitudinal axis B.

In addition, longitudinal positioning of the plate 36 in relation to the structure element 22 is provided by the fact that at least one of the two branches 50 of the clamp 46 is fixed to the structure element 22.

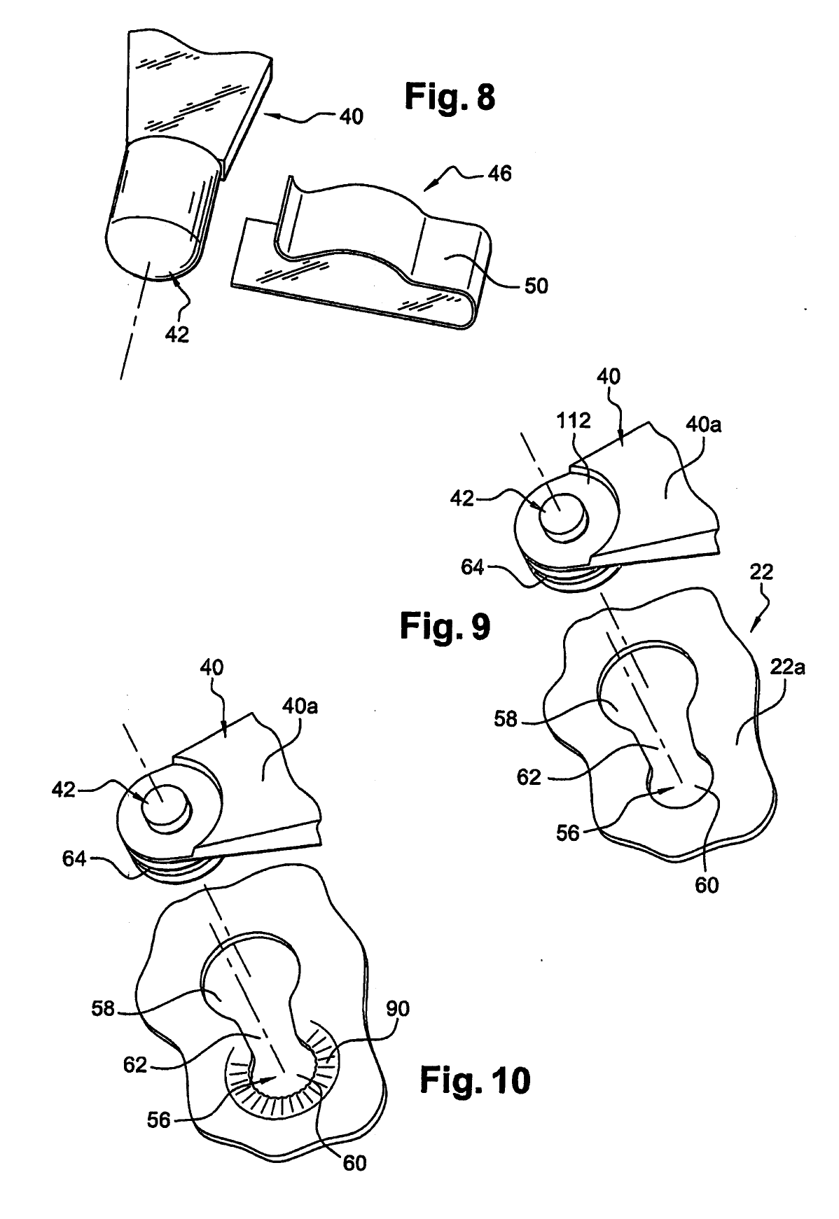

FIGS. 7 and 8 show an alternative method for producing the clamp-shaped support elements 46 according to which the front branch 50 of the clamp 46 consists of a spring wire or a band that is either fixed to the front face 22a of the structure element, as shown in FIG. 7, or which is formed integral with the structure element 22, in this case by cutting and bending a part of the structure element 22.

The clamp 46 is thus made up of this band of material 50 and by the structure element 22.

FIG. 9 shows another embodiment of the means for joining the plate 36 to the front face 22a of the structure element 22, according to which the free end 40a of the radial arm 40 has a finger 42 that extends longitudinally, and which is received in an opening 56 made in the front face 22a of the structure element 22. The external cylindrical wall of the finger 42 comprises a peripheral radial gorge 64, in which the edge of the opening 56 is partly received.

This opening 56 comprises a first orifice 58 which is globally circular with a diameter that is at least equal to the outer diameter of the finger 42, a second orifice 60 with a diameter that is smaller than the outer diameter of the finger 42, and larger than the inner diameter of the peripheral gorge 64, and an intermediate groove 62 which connects the two orifices 58, 60, which has a width that is smaller than the inner diameter of the gorge 64.

The first orifice 58 is arranged on the structure element 22 such as to extend longitudinally opposite the finger 42 during the first step for positioning the plate in relation to the front face 22a of the structure element 22, to enable the finger 42 to be inserted in the opening 56 during the first step.

Furthermore, by the end of the first positioning step, the plate 36 is positioned longitudinally in relation to the front face 22a of the structure element 22 in order for the gorge 64 of the finger 42 to be located at the same longitudinal height as the structure element 22, in other words, on the plane of the orifice 58.

The second orifice 60 and the intermediate groove 62 are arranged on the structure element 22 so that, during the second joining step, the finger 42 moves in the intermediate groove 62 and then enters the second orifice 60, with the edge of the groove 62 and the second orifice 60 following one another in the gorge 64 of the finger 42.

Since the width of the intermediate groove 62 is smaller than the diameter of the bottom of the gorge 64 of the finger 42, when the finger 42 is in its position in the second orifice, the groove 62 blocks the finger 42 in the second orifice 60 of the opening 56.

FIG. 10 shows an alternative embodiment of the opening 56, according to which a part 90 of the structure element 22, which extends around the second orifice 60, is formed so that, when the finger 42 is in position in the second orifice 60, it partly blocks the finger 42 in the second orifice 60.

For this purpose, this part 90 of the structure element 22, which has the global shape of a disc that is coaxial to the second orifice 60, comprises radial corrugations, in relation to the longitudinal axis of the second orifice 60.

Due to these corrugations of the part 90 of the structure element 22, the peripheral edge of the second orifice 60 is corrugated, with greater longitudinal amplitude than the width of the gorge 64 of the finger 42. For this reason, when the finger 42 is in position in the second orifice 60, the corrugated edge of the second orifice is inserted by force in the gorge 64 of the finger 42, thus additionally blocking the finger 42 in the second orifice 60 by means of friction.

FIGS. 11a and 11b show another alternative embodiment of the finger 42, which locks the finger 42 in mounted position in the opening 56.

Here, the finger 42 consists of an element that is fixed to the free end 40a of the radial arm 40 by means of a hook 92 arranged on the free end 40a of the radial arm 40.

The finger 42 comprises a globally cylindrical body 94 with a longitudinal main axis C, the front longitudinal end 94a of which is fixed to the hook 92 of the radial arm 42, and the rear longitudinal end 94b of which is received in the opening 56, which is produced according to one of the embodiments described previously. For this purpose, the rear end 94b comprises the gorge 64 that receives the peripheral edge of the second orifice 60.

The finger 42 also comprises a locking tab 96, which extends globally radially in relation to the axis C of the body 94. The free radial end 96a of this locking tab comprises a ramp-shaped portion 98, which is suited for resting against a portion 100 of the structure element 22, which is also ramp-shaped, during the second step of joining the plate 36, in other words, when the finger 42 is shifted tangentially in relation to the longitudinal axis B in the opening 56.

When the ramp-shaped portion 98 of the fixing tab 96 is resting against the portion 100 of the structure element 22, the fixing tab 96 distorts elastically forwards and then, when the finger 42 is in its position in the second orifice 60, the fixing tab 96 returns elastically to its initial shape shown in FIG. 11b, in which the ramp-shaped portion 98 is received in the first orifice 58.

The radial end edge 98a of the ramp-shaped portion 98 thus rests against the edge opposite the first orifice 58, in order to prevent the finger 42 from moving back into the opening 56, in a disconnection movement.

FIGS. 5a to 5c show another embodiment of the blocking means, according to which the free end 40a of each radial arm 40 has several parallel fingers 66, which extend globally radially.

These fingers 66 are arranged so that, at the end of the second joining step, they extend on either side of the structure element 22, exerting a longitudinal tightening effort of the structure element 22.

This tightening effort makes it possible, on the one hand, to prevent any longitudinal forward or backward movement of the plate 36 in relation to the structure element 22 and on the other hand, to prevent any rotation of the plate 36 in relation to the structure element 22, around the longitudinal axis B by friction.

Here, each radial arm 40 has three radial fingers 66, which are arranged so that, at the end of the joining step, a first radial finger 66a rests against the rear face 22b of the structure element 22, and the other two radial fingers 66b rest against the front face 22a of the structure element 22.

In addition, the structure element 22 comprises an opening 68 associated to each radial arm 40, which allows the first radial finger 66a and a part of the radial arm 40 to pass through it and move towards the rear of the structure element 22, during the two steps of positioning and joining the plate 36 in relation to the structure element 22.

FIG. 6 shows another embodiment of the blocking means, in which each radial arm 40 has a radial finger 42 on its free radial end 40a, and according to which, the structure element 22 is formed by cutting and bending in order to create, for each of the fingers 42, a first front part 102 and a second rear part 104.

The first part 102 comprises a flat part extending in a vertical longitudinal plane located in front of the front face 22a of the structure element 22, and it comprises a hollow shape 108 that is rounded out forwards. This hollow shape 108 is globally complementary to the shape of the finger 42, and it is suited for receiving the free radial end of the radial finger 42, at the end of the second step for joining the plate 36 to the structure element 22.

The first part also comprises a rear portion 106 in relation to the rotation movement of the plate 36 around the longitudinal axis B, which is distorted longitudinally forwards, to allow the radial finger 42 to be inserted between the two parts 102, 104.

The second part 104 consists of a rear reinforcement of the front face 22a of the structure element 22, which is globally complementary to the radial finger 42.

Thus, at the end of the second step for joining the plate 36 to the structure element 22, the finger 42 is arranged longitudinally between the two hollow portions 108, 104, which also exert a tightening effort on the finger 42.

Thus, these hollow portions 108, 104 ensure the longitudinal positioning of the plate 36 in relation to the structure element 22, as well as the angular positioning of the plate 36 around the longitudinal axis B.

FIGS. 2a to 2c show another embodiment of the means for joining the plate 36 in relation to the structure element, according to which a band of material 70 forming a clamp, which is formed integral with the structure element 22, for example, by cutting and bending, at least partly covers the body of the motor 28, to ensure the angular position of the plate 36 around the longitudinal axis B, as well as the angular and longitudinal blocking of the plate 36 in relation to the structure element 22.

This band of material 70 can, as an alternative, consist of an added element that is fixed to the structure element 22, for example by welding.

The free end 70a of the band of material 70, which extends backwards in relation to the joining movement around the longitudinal axis B, is curved forwards so that, during the joining movement of the plate 36 to the structure element 22, the motor 28 rests against this free end 70a in order to cause the band of material 70 to distort elastically and the clamp to open, thus allowing the motor 28 to pass through it. When the plate 36 is in its mounted position in relation to the structure element 22, the band of material returns elastically to the position in which it blocks the motor, which it overlaps and surrounds closely with no play, providing the function of an elastic clamp of the motor.

The vehicle, as well as the driving mechanism 26, generates vibrations of the driving mechanism 26 in relation to the structure element 22, with various amplitudes and frequencies.

These vibrations can cause the blocking means to come loose, and thus cause the plate 36 to come loose from the structure element 22.

In order to prevent this disconnection, and according to another aspect of the invention, the driving mechanism 26 is arranged so that its centre of gravity is shifted transversally in relation to the longitudinal axis B, so that the driving mechanism 26 is brought back to its locking position by means of the pull of gravity.

According to a further aspect of the invention and as can be seen mainly in FIGS. 3a to 3c and 5a to 5c, the plate comprises an additional radial arm 72, the free end of which is designed to be joined to the structure element 22 by means other than elastically fitting together complementary shapes in order to lock the plate 36 in its mounted position on the structure element 22, after the second joining step.

Here, as can be seen in the figures, the locking means comprise a longitudinal locking screw 74 which passes through an orifice 76 in the additional radial arm 72, and which works with a complementary threaded hole 78 of the structure element 22 or supported by the latter.

The screw can be replaced with any element or equivalent means, such as a “clippable” finger, a rivet, a pin, etc.

Several different embodiments of the means for joining the plate 36 to the front face 22a of the structure element 22 have been described.

However, it is understood that the invention is also applicable to an arrangement comprising several joining means according to only one of the embodiments described previously, as well as to an arrangement that comprises a combination of joining means according to various embodiments described previously.

FIGS. 12a to 12c show an example of an embodiment of means for joining the plate 36 with the structure element 22 according to the alternative embodiment of the invention, in which the movement of the second joining step consists of a longitudinal translation movement towards the rear, parallel to the longitudinal axis B.

According to this embodiment of the joining means, the structure element 22 has fingers 80 that extend longitudinally forwards from the front face 22a of the structure element 22, and which are received in complementary housings 82 of the radial fingers 42.

According to this embodiment, the structure element 22 and the plate 36 comprise several sets of longitudinal fingers 80 and complementary housings 82, three in this case, distributed angularly, in order to ensure the angular position of the plate 36 around the longitudinal axis B in relation to the structure element 22.

Locking of the plate 36 in the longitudinal position in relation to the structure element 22 is ensured by means of external retaining rings 84 which, as can be seen in greater detail in FIG. 13, block the longitudinal movement of the fingers 80 by buttressing on the peripheral cylindrical surface of these fingers. These axis-retaining rings are, for example, of the type known by the name “GRIFFAXE”.

As an alternative embodiment, the fingers 80 are made from a material that can distort plastically under the action of the retaining rings 84. According to yet another alternative embodiment, not shown, the free end of the fingers 80 has a gorge that receives the internal edge of the associated retaining ring 84 in order to provide longitudinal locking.

Finally, to provide locking in the position as shown in FIG. 14, each finger 80 has a transverse orifice 86, which receives a pin 88.

As alternative embodiments not shown in the figures, the fingers 80 can be placed on the radial arms 40 and extend longitudinally towards the rear in order to be received in the complementary housings 82 that are made in the structure element 22.

As mentioned previously, the driving mechanism 26 generates a considerable amount of vibrations. These vibrations, when they are transmitted to the structure element 22, cause it to vibrate, which produces a very unpleasant noise for the persons who are inside the vehicle.

This is why, as can be seen in the figures, damping elements, made mainly from natural or artificial rubber, are placed between the plate 36 and the structure element 22.

These damping elements thus comprise a first damper 110, which is supported by the structure element 22 or the barrel 38, and which covers the edge of the orifice 34 of the structure element 22 so that, when the plate is in its mounted position on the structure element 22, the first damper 110 is placed between the external cylindrical face 38e of the barrel 38 and the edge of the orifice 34. Since it is made from a natural or synthetic rubber or an elastomer material, this damping element is a hermetic piece. It can also absorb manufacturing tolerances of the vehicle body.

Likewise, each radial finger 42 can be made in the shape of a sleeve or a socket made from a material that can be elastically distorted, in the way of a chassis mounting rubber, made from natural or synthetic rubber or an elastomer material. In addition, this design of each finger 42 or its equivalent or analogue components according to the various embodiments, in the shape of vibration dampers, facilitate assembly, according to the method of the invention, during the joining step thanks to their capacity for elastic distortion to facilitate the fitting together of complementary shapes.

1. A method for assembling a windscreen-wiper mechanism comprising a support plate on an internal face of a body structure element that extends globally vertically at a rear of a motor vehicle, the method successively comprising:
a step of positioning the support plate relative to the internal face of the body structure element; and
a step of joining the plate to the internal face of the body structure element, wherein
the positioning step of comprises moving the plate relative to the body structure element along a first direction, and
the joining step comprises rotating the plate about the first direction.

2. The assembly method according to claim 1, wherein the support plate comprises at least one driving shaft of a wiping blade, along a longitudinal main axis, through an opening in the body structure element, wherein the first direction is parallel to the longitudinal axis of the driving shaft.

3. The assembly method according to claim 2, wherein the positioning and joining steps of comprise successive longitudinal front-to-back translation movements of the plate relative to the body structure element.

4. The assembly method according to claim 2, wherein the positioning and joining steps comprise successive longitudinal front-to-back translation movement of the plate relative to the body structure element and then in a rotation movement of the plate relative to the body structure element around the longitudinal axis of the driving shaft.

5. The assembly method according to claim 1, further comprising a step of locking the plate in a mounted position on the internal face of the body structure element.

6. An arrangement for mounting and fixing a windscreen-wiper mechanism following a method according to claim 2, wherein the plate comprises means for being positioned coaxially to the longitudinal axis of the driving shaft and means for being positioned angularly around the longitudinal axis.

7. The arrangement according to claim 6, wherein the plate comprises a cylindrical barrel with a circular section for guiding rotation of the driving shaft, that is adapted to be received in a complementary housing of the body structure element to provide the positioning coaxially relative to the longitudinal axis and to provide the water-tightness of a point where the structure element is crossed.

8. The arrangement according to claim 6, wherein the plate or the body structure element has a finger with longitudinal orientation or radial orientation relative to the longitudinal axis, that is received in a complementary housing of the body structure element or of the plate, respectively, for angular positioning of the plate around the longitudinal axis.

9. The arrangement according to the claim 8, wherein the finger is maintained in a mounted position in an associated housing by means of fitting together complementary shapes, mainly by elastic fitting of elements that also form vibration dampers.

10. The arrangement according to claim 6, wherein the body structure element or the plate has an elastic clamp having a globally tangential orientation to the longitudinal axis, that receives a finger of the plate or the body structure element, respectively, for angular positioning of the plate around the longitudinal axis and for maintaining the plate in is a mounted position on the body structure element.

11. The arrangement according to claim 10, wherein at least one branches of the clamp comprises a boss that projects from is a face opposite another branch of the clamp, towards an inside of the clamp, and is adapted to be received in a complementary hollow housing of an associated finger.

12. The arrangement according to claim 6, wherein the body structure element has an elastic clamp that is adapted to receive an external body of a motor for driving a wiping mechanism, for angular positioning of the plate around the longitudinal axis and for maintaining the plate in a mounted position relative to the body structure element.

13. The arrangement according to claim 10, wherein the body structure element comprises a transversal plate to which the plate of the wiping device is fixed.

14. The arrangement according to claim 13, wherein the clamp is formed integral, by bending and cutting the transverse plate.

15. The arrangement according to claim 13, wherein the plate has at least one clamp, the branches of which are arranged on either side of the transverse plate.

16. The arrangement according to claim 13, wherein the plate has at least one longitudinal finger, the outer cylindrical wall of which comprises a peripheral gorge, and wherein the finger is suited to be inserted in a groove of the transverse plate so that, when the plate is in mounted position on the transverse plate, the edge of the groove is received at least partly in the gorge of the finger.

17. The arrangement according to claim 16, wherein the edge of the groove comprises radial corrugations relative to the axis of the finger for preventing the finger from moving inside the groove.

18. The arrangement according to claim 16, wherein the finger has a locking tab that is received at least partly in the groove, for locking the finger in position in the groove.

19. The arrangement according to claim 8, wherein the finger is arranged radially at a distance from the longitudinal axis of the driving shaft.

20. The arrangement according to claim 10, wherein the clamp has a globally tangential orientation relative to the longitudinal axis.

21. The arrangement according to claim 6, wherein the plate has a portion that is adapted to be joined to the body structure element by a locking element with axial action, mainly by a screw.

22. The arrangement according to claim 8, further comprising at least one finger with longitudinal orientation received in a complementary housing and means for axially immobilizing at least one finger in its complementary housing.
